(19) United States
(12) Patent Application Publication
(10) Pub. No.: US 2016/0195965 A1
(43) Pub. Date: Jul. 7, 2016

(54) DISPLAY DEVICE

(71) Applicant: SAMSUNG DISPLAY CO., LTD., Yongin-City (KR)

(72) Inventors: Tae Sik KIM, Seoul (KR); Dong Suk CHOI, Suwon-si (KR)

(21) Appl. No.: 14/713,035

(22) Filed: May 15, 2015

(30) Foreign Application Priority Data
Jan. 7, 2015 (KR) 10-2015-0001888

(51) Int. Cl. G06F 3/047; G09G 5/00

(52) U.S. Cl. CPC G06F 3/047; G09G 5/003; G09G 2300/0426

(57) ABSTRACT

A display device includes a display panel, a window, a plurality of first touch patterns, a plurality of second touch patterns, and a touch pad region. The display panel includes a display area and a non-display area. The window covers the display panel and including a black matrix area. The first touch patterns are in the display area, and the second touch patterns are in the black matrix area. The touch pad region is in the non-display area, and includes a plurality of first touch pads to transmit first sensing signals sensed by the first touch patterns to a predetermined destination and a plurality of second touch pads to transmit second sensing signals sensed by the second touch patterns to the predetermined destination.

### CROSS-REFERENCE TO RELATED APPLICATION

Korean Patent Application No. 10-2015-0001888, filed on Jan. 7, 2015, and entitled, “Display Device,” is incorporated by reference herein in its entirety.

### BACKGROUND

1. Field

One or more embodiments described herein relate to a display device.

2. Description of the Related Art

A display has been developed to include built-in touch patterns. These patterns allow a user to input a command by selecting instructions on a screen using a finger or object. One display of this type is an on-cell touch active matrix organic light emitting diode (OCTA) displays. An OCTA display has touch patterns on an upper substrate corresponding to a display area. Sensing signals from the touch patterns are delivered to an external destination via a touch flexible printed circuit board (FPCB) attached to a side of the upper substrate.

In effort to improve design quality, side keys may be provided in a non-display area of the OCTA display in order to select various settings or control power in a touch manner. The side keys correspond to touch patterns in the non-display area, and the display area also includes touch patterns. Because the touch patterns in the display and non-display areas are both on the upper substrate. a coupling phenomenon may occur between the touch patterns in the display area and non-display areas.

In an attempt to solve this problem, touch patterns in the display area may be separated from the touch patterns in the non-display area. However, this approach increases the size of the non-display area. In addition, the touch FPCB includes a bending region to allow the touch FPCB to be attached to the upper substrate of the OCTA. This bending region also increases the size of the non-display area. Also, these effects increase the size of a bezel region of the display to deteriorate design quality.

### SUMMARY

In accordance with one or more embodiments, a display device includes a display panel including a display area and a non-display area; a window to cover the display panel and including a black matrix area; a plurality of first touch patterns in the display area; a plurality of second touch patterns in the black matrix area; and a touch pad region in the non-display area, the touch pad region including a plurality of first touch pads to transmit first sensing signals sensed by the first touch patterns to a predetermined destination and a plurality of second touch pads to transmit second sensing signals sensed by the second touch patterns to the predetermined destination.

A surface of the window may include an edge area, and the black matrix area may be in the edge area and does not overlap the display panel. The black matrix area may include a printing layer on a window substrate; a plurality of metal lines on the printing layer; and the second touch patterns connected to the metal lines. The metal lines may be connected to a window pad region on the surface of the window. The first touch patterns may include an optically transparent, light-transmitting metal material, and the second touch patterns may include a metal material. The window pad region may be on an area of the surface of the window which corresponds to the non-display area. The display device may include a metal pattern to electrically connect the window pad region and the second touch pads. The metal pattern may penetrate an insulating layer between the display panel and the window.

In accordance with one or more other embodiments, a display device includes a display panel including a first substrate having a pixel region and a second substrate on the first substrate; a plurality of touch patterns on the second substrate; a touch pad region on the second substrate and including a plurality of touch pads to deliver sensing signals sensed by the touch patterns to a predetermined destination; a connection pad region on the first substrate and including a plurality of connection pads to deliver the sensing signals sensed by the touch patterns to the predetermined destination; a connector to connect the touch pad region and the connection pad region; and a flexible printed circuit board (FPCB) which is connected to a side of the first substrate to deliver an image signal from an external source to the pixel region or which is connected to the connection pad region to deliver the sensing signals to the predetermined destination.

The connector may include an insulating layer on the display panel; and a metal pattern which penetrates the insulating layer to connect the touch pad region and the connection pad region. The first substrate may include a first metal wiring region to connect the connection pad region and the FPCB; a driver integrated circuit (IC) to receive an image signal from the FPCB. generate a pixel driving control signal for the pixel region based on the image signal. and transmit the pixel driving control signal to the pixel region; and a second metal wiring region to connect the driver IC and the FPCB.

In accordance with one or more other embodiments, a display device includes a display panel including a first substrate having a pixel region and a second substrate on the first substrate; a window on the display panel; a plurality of first touch patterns on the second substrate; a touch pad region on the second substrate and including a plurality of first touch pads to receive first sensing signals sensed by the first touch patterns; a plurality of second touch patterns on a surface of the window; a window pad region on the surface of the window and including a plurality of window pads to receive second sensing signals sensed by the second touch patterns; a connection pad region on the first substrate and including a plurality of connection pads to deliver the first and second sensing signals to a predetermined destination; and a connector to connects the window pad region, the touch pad region, and the connection pad region.

The touch pad region may include a plurality of second touch pads to receive the second sensing signals from the window pad region. The connector may connect the window pad region to the second touch pads. The second touch patterns may be in a black matrix area of the window, and the black matrix area may be an edge area of the surface of the window.

The black matrix area may include a printing layer on a window substrate; a plurality of metal lines which on the printing layer and connected to the window pad region; and the second touch patterns connected to the metal lines. The connector may include an insulating layer between the display panel and the window; and a metal pattern which penetrates the insulating layer in a bridge shape to connect the window pad region, the touch pad region, and the connection pad region.

The display device may include an FPCB connected to the connection pad region to deliver the first and second sensing signals to the predetermined destination. The first substrate may include a first metal wiring region to connect the connection pad region and the FPCB; a driver IC to receive an image signal from the FPCB, generate a pixel driving control signal for the pixel region based on the image signal, and transmit the pixel driving control signal to the pixel region; and a second metal wiring region to connect the driver IC and the FPCB. A size of the window may be greater than a size of the display panel to cover the display panel.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display device;

FIG. 2 illustrates a view along section line I-I′ in FIG. 1;

FIG. 3 illustrates an embodiment of a window;

FIG. 4 illustrates a view along section line II-II′ of FIG. 3;

FIG. 5 illustrates an embodiment of a display panel;

FIG. 6 illustrates a view along section line III-III′ of FIG. 5;

FIG. 7 illustrates a view along section line IV-IV′ of FIG. 5; and

FIG. 8 illustrates a view along section line V-V′ of FIG. 5.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments. Like reference numerals refer to like elements throughout.

It will be understood that when an element or layer is referred to as being “on”, “connected to”, or “coupled to” another element or layer, it can be directly on, directly connected to, or directly coupled to the other element or layer, or intervening elements or layers may be present. In contrast, when an element is referred to as being “directly on,” “directly connected to”, or “directly coupled to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ). As used herein, the term “and/or” includes any and all combinations of one or more of the associated listed items.

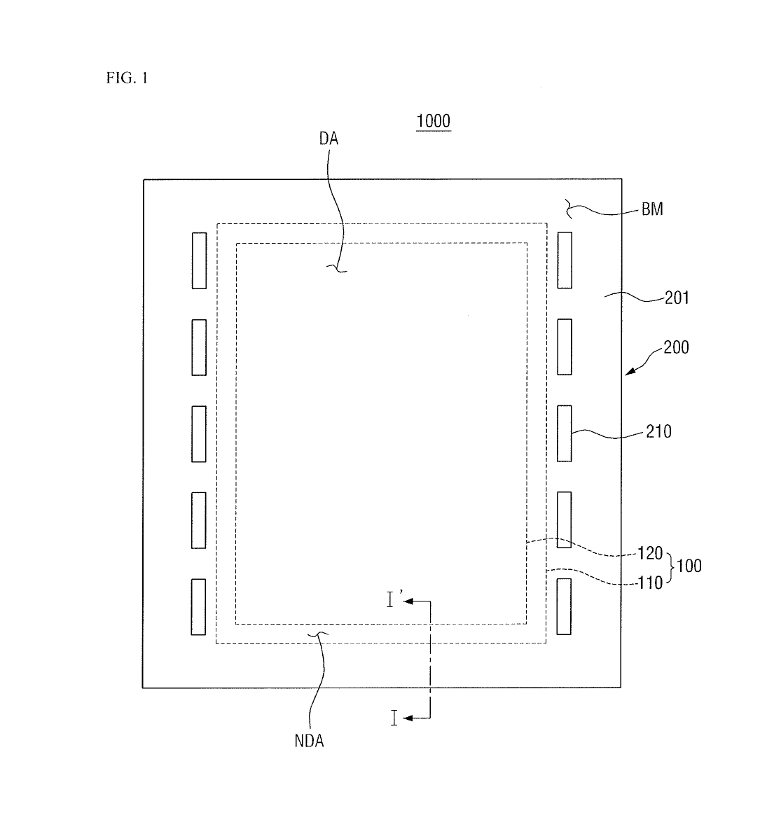

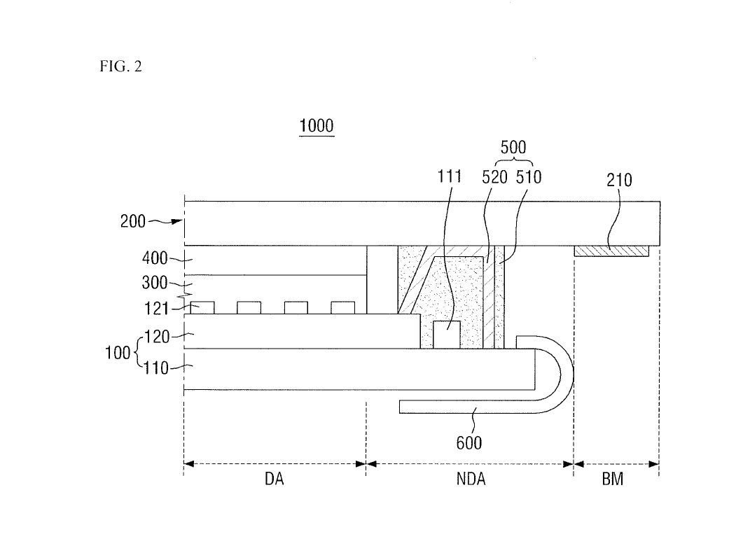

FIG. 1 illustrates an embodiment of a display device 1000, and FIG. 2 is a cross-sectional view taken along line in FIG. 1. Referring to FIGS. 1 and 2, the display device 1000 includes a display panel 100, a window 200, a polarizer 300, an adhesive layer 400, a connector 500, and a flexible printed circuit board (FPCB) 600.

The display panel 100 includes a pixel unit between a first substrate 110 and a second substrate 120. The display panel 100 also includes a display area DA including the pixel unit to display images and a non-display area NDA adjacent to and/or surrounding the display area DA.

The pixel unit may include a plurality of scan lines, a plurality of data lines, and a plurality of pixels in regions defined by the scan lines and the data lines. Each pixel may include a switching device and a light-emitting device. The switching device (e.g., a thin-film transistor (TFT)) is turned on or off based on a control signal from, for example, an external printed circuit board (PCB). The light-emitting device emits light under control of the switching device. The light-emitting device may be, for example, an organic light-emitting diode (OLED).

The non-display area NDA includes an driver integrated circuit (IC) 111, a connection pad unit, a first metal wiring region, and a second metal wiring region.

Elements in the display area DA and elements in the non-display area NDA may be disposed on the first substrate 110 of the display panel 100. For example, the pixel unit, the driver IC 111, the connection pad unit, the first metal wiring region, and the second metal wiring region may be on the first substrate 110. The second substrate 120 may be on the first substrate 110 with the pixel unit interposed there between.

In one embodiment, the second substrate 120 may be smaller than the first substrate 110. Accordingly, the driver IC 111, the connection pad unit. the first metal wiring region. and the second metal wiring region on the first substrate 110 may be exposed. In addition, a plurality of first touch patterns 121 may be on the second substrate 120 to sense a region touched by a finger or an object such as a stylus pen.

The window 200 covers the display panel 100 including the display area DA and the non-display area NDA. The window 200 faces the display panel 100 and may be made of a transparent material. A window substrate 201 is made of a transparent material (e.g., glass or resin) and protects the display panel 100 from external impact. The window 200 may be larger than the display panel 100 to cover the entire display panel 100. In another embodiment, the window 200 may be the same size as display panel 100.

The window 200 may include a black matrix area BM in an edge area of a surface of the window substrate 201. A plurality of second touch patterns 210 may be in the black matrix area BM. In FIG. 2, the black matrix area BM is outside the non-display area NDA of the display panel 100. In another embodiment, if the window 200 is the same size as the display panel 100, the non-display area NDA of the display panel 100 may correspond to the black matrix area BM. Since the second touch patterns 210 in the non-display area NDA of the display panel 100 are placed in the black matrix area BM of the window 200, a coupling phenomenon between the first touch patterns 121 and the second touch patterns 210 may be prevented

Light incident into the display device 1000 and then reflected may be mixed with light emitted from the light-emitting devices of the pixel unit, thereby reducing contrast ratio. To prevent this effect, the polarizer 300 may be disposed on the second substrate 120 to correspond to the display area DA. In another embodiment, the polarizer 300 may be omitted.

The adhesive layer 400 bonds window 200 to the display panel 100, to which the polarizer 300 is attached. The adhesive layer 400 may include a resin, e.g., an optically clear adhesive.

The connector 500 includes an insulating layer 510 and a metal pattern 520.

The insulating layer 510 may be between the display panel 100 and the window 200 to compensate for a step difference between the display panel 100 and the window 200 and to reinforce the display device 1000. The metal pattern 520 penetrates the insulating layer 510 in a bridge shape to electrically connect the connection pad unit on the first substrate 110, a touch pad unit on the second substrate 120, and a window pad unit on the window 200. First sensing signals sensed by the first touch patterns 121 on the second substrate 120 and second sensing signals sensed by the second touch patterns 210 on the window 200 may be transmitted to an external destination through the metal pattern 520 of the connector 500. This negates the need for a touch FPCB for delivering touch sensing signals to an external destination. Accordingly, the number of parts may be reduced, and the size of a bezel region may also be reduced because a bending region of the touch FPCB does not exist.

The FPCB 600 is connected to the second metal wiring region in the non-display area NDA of the first substrate 110 in order to deliver a control signal received from an external source to the driver IC 110. In another embodiment, the FPCB 600 is connected to the first metal wiring region on the first substrate 110 in order to deliver touch sensing signals received from the first touch patterns 121 of the second substrate 120 and the second touch patterns 210 of the window 200 to an external destination.

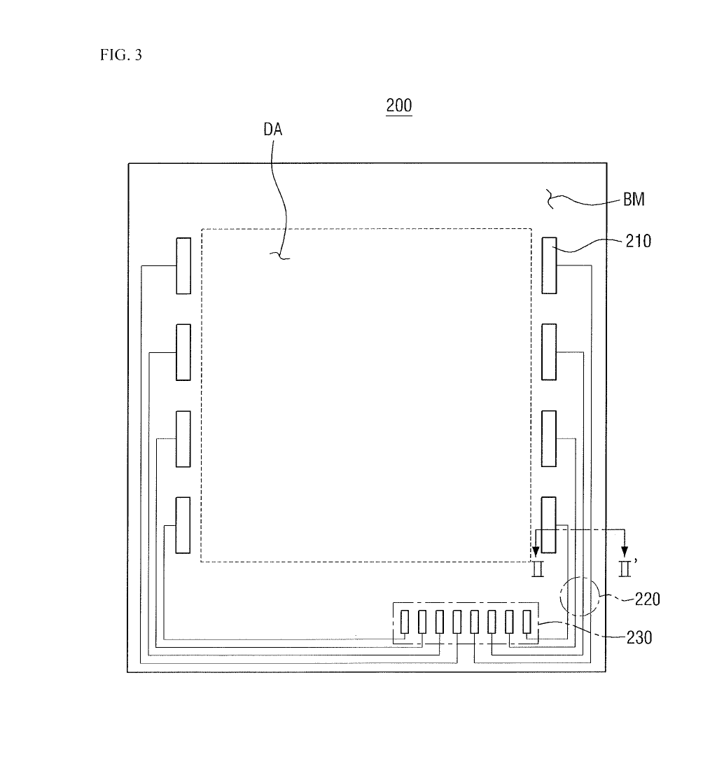

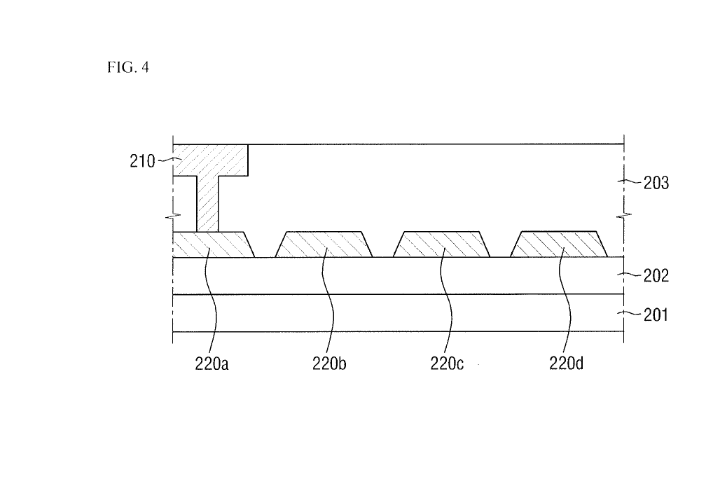

FIG. 3 illustrates an embodiment of the window 200, and FIG. 4 is a cross-sectional view taken along line II-II′ in FIG. 3. Referring to FIGS. 3 and 4, the window 200 includes a display area DA and a black matrix area BM. The black matrix area BM includes a printing layer 202 on a window substrate 201, a plurality of second touch wiring lines 220a, 220b, 220c, 220d on the printing layer 202, a plurality of second touch patterns 210 connected to the second touch wiring lines 220a on the printing layer 202, and a window pad unit 230 connected to the second touch wiring lines 220a.

The second touch patterns 210 may be on the printing layer 202 formed on the window substrate 201 in the black matrix area BM and may sense a touch. The second touch patterns 210 may include a conductive material and may be resistive or capacitive touch patterns. In one embodiment, the second touch patterns 210 may not be made of a transparent material because they are formed in the black matrix area BM. Since the second touch patterns 210 are on the window substrate 201 in the black matrix area BM, the coupling phenomenon of the second touch patterns 210 to the first touch patterns 121 (see FIG. 2) on the second substrate 120 may be prevented. In another embodiment, the second touch patterns 210 may be made of a transparent material.

The second touch wiring lines 220 may be on the printing layer 202 formed on the window substrate 201 in the black matrix area BM. and may respectively be connected to the second touch patterns 210 to deliver sensing signals sensed by the second touch patterns 220 to the window pad unit 230.

The window pad unit 230 receives signals sensed by the second touch patterns 210 through the second touch wiring lines 220, and transmits the received signals to an external circuit. The window pad unit 230 may transmit signals sensed by the second touch patterns 210 to the FPCB 600 via the metal pattern 520. In addition, the window pad unit 230 may be connected to a plurality of second touch pads on the second substrate 120 via the metal pattern 520.

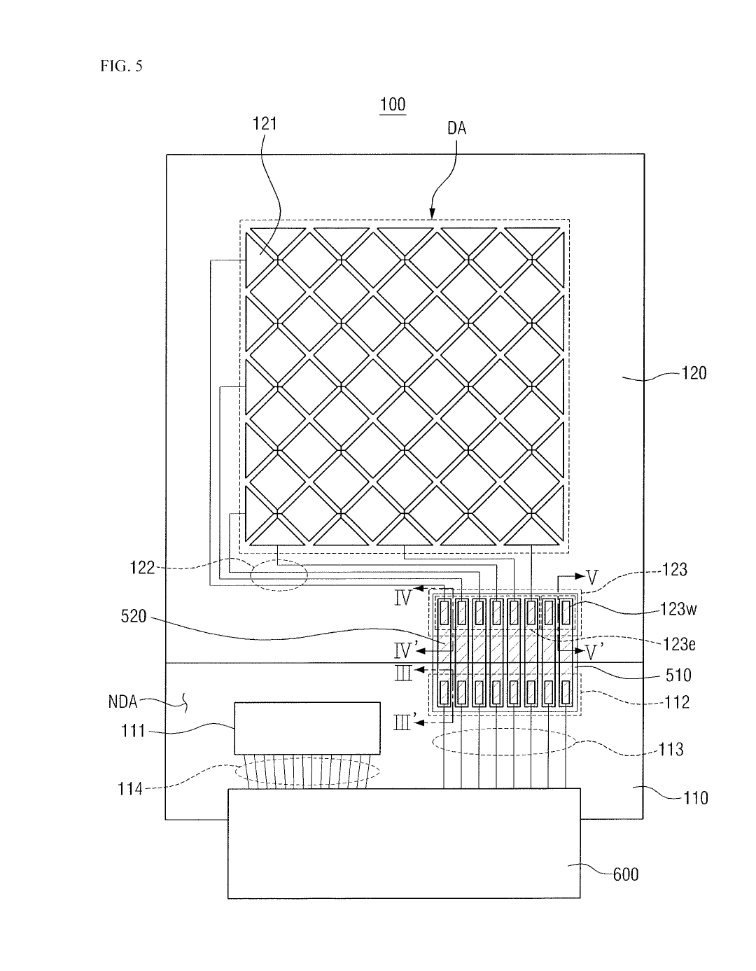

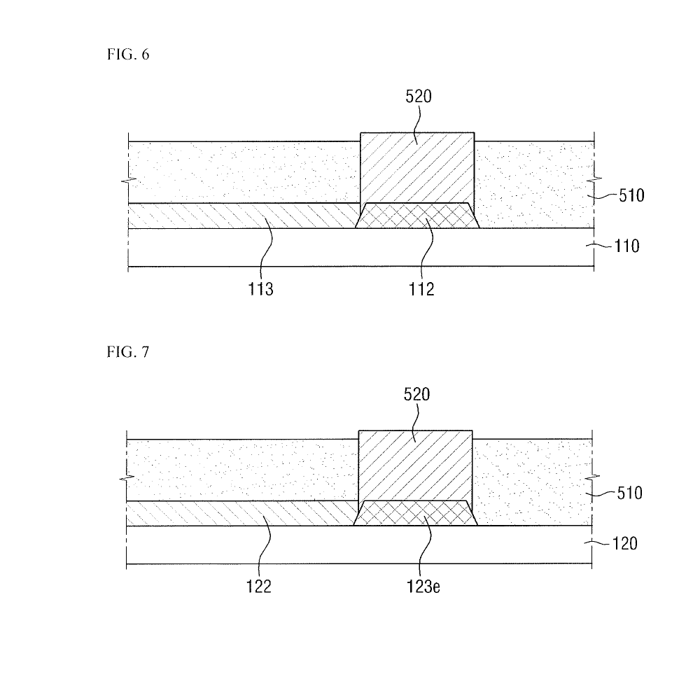

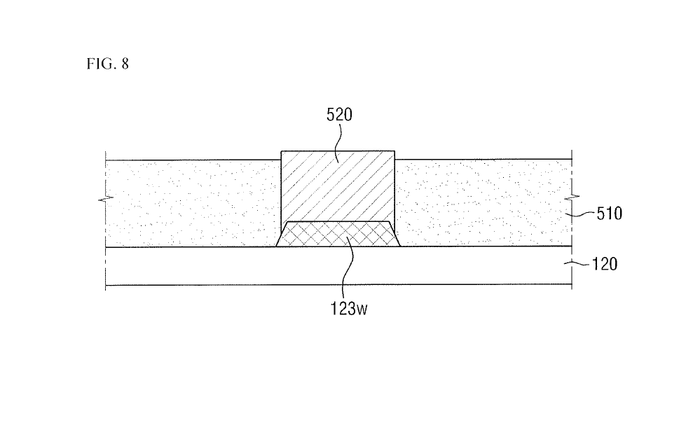

FIG. 5 illustrates an embodiment of the display panel 100. FIG. 6 is a cross-sectional view taken along line in FIG. 5. FIG. 7 is a cross-sectional view taken along line IV-IV′ in FIG. 5. FIG. 8 is a cross-sectional view taken along line V-V′ in FIG. 5.

Referring to FIGS. 5 through 8, the display panel 100 includes a first substrate 110 and a second substrate 120 as described above. The first substrate 110 may include a transparent material such as tempered glass, acrylic resin, polyethylene terephthalate (PET), polycarbonate (PC), polyimide (PI), polyethersulfone (PES), polymethly methacrylate (PMMA), polyethylene naphthalate (PEN), metal foil, fiber reinforced plastic (FRP), or silicon rubber. The first substrate 110 may include a rigid material. In another embodiment, the first substrate 110 may also include a ductile material such as a flexible material. A pixel unit, a driver IC 111, a connection pad unit 112, a first metal wiring region 113, and a second metal wiring region 114 may be formed on the first substrate 110.

The driver IC 111 receives an image signal from an external source, generates a pixel control signal for controlling driving of the pixel unit based on the image signal, and transmits the pixel control signal to a plurality of scan lines and a plurality of data lines. The driver IC 111 may be mounted on the first substrate 110 using, for example, chip-on-glass (COG) or chip-on-film (COF) technology.

The connection pad unit 112 includes a plurality of connection pads. The connection pads are respectively connected to a plurality of touch pads in a touch pad unit 123 of the second substrate 120 by a metal pattern 520 of a connector 500. The connection pad unit 112 may contact the first substrate 110 as illustrated in FIG. 6. The connection pad unit 112 is electrically connected to the first metal wiring region 113 on the first substrate 110 to contact the first substrate 110. An insulating layer 510 of the connector 500 is deposited on the connection pad unit 112. A contact hole is formed in the deposited insulating layer 510 to expose an upper portion of the connection pad unit 112. The metal pattern 520 is formed of a metal material in the contact hole such that it is connected to the touch pad unit 123 of the second substrate 120.

The first metal wiring region 113 electrically connects the connection pad unit 112 and an FPCB 600. Thus, the first metal wiring region 113 receives first sensing signals sensed by a plurality of first touch patterns 121 and second sensing signals sensed by a plurality of second touch patterns 210 from the connection pad unit 112 and delivers the first and second sensing signals to the FPCB 600.

The second metal wiring region 114 electrically connects the driver IC 111 and the FPCB 600 to deliver an image signal from an external source to the driver IC 111.

The second substrate 120 may include a material similar to that of the first substrate 110, e.g., a transparent material such as tempered glass. acrylic resin, PET, PC, PI, PES, PMMA, PEN, metal foil, FRP, or silicon rubber. The second substrate 120 may include a rigid material. In another embodiment, the second substrate 120 may also include a ductile material such as a flexible material.

The first touch patterns 121 may include an optically transparent, light-transmitting conductive material. The optically transparent conductive material may correspond not only to a conductive material that is transparent, but also a conductive material that is opaque but is perceived as transparent when seen with the naked eye, because basic constituent units of the conductive material are very small and arranged at an appropriate density.

A plurality of first touch wiring lines 122 are electrically connected to the first touch patterns 121 to deliver the first sensing signals sensed by the first touch patterns 121 to the touch pad unit 123.

The touch pad unit 123 includes a plurality of first touch pads 123e and a plurality of second touch pads 123w. The first touch pads 123e are electrically connected to the first touch wiring lines 122 to deliver the first sensing signals received through the first touch wiring lines 122 to an external circuit. The first touch pads 123e may contact the second substrate 120 as illustrated in FIG. 7. The first touch pads 123e are electrically connected to the first touch wiring lines 122 on the second substrate 120 to contact the second substrate 120, and the insulating layer 510 of the connector 500 is formed on the first touch pads 123e. A contact hole is formed in the insulating layer 510 to expose upper portions of all of the first touch pads 123e. The metal pattern 520 includes a metal material in a bridge shape within the contact hole to allow for connection to the connection pad unit 112 of the first substrate 110.

The second touch pads 123w may be electrically connected to a window pad unit 230 on a window substrate 201 to deliver the second sensing signals sensed by the second touch patterns 210 on the window substrate 201 to an external circuit. The second touch pads 123w may contact the second substrate 120 as illustrated in FIG. 8. The insulating layer 510 of the connector 500 is on the second touch pads 123w. A contact hole is formed in the insulating layer 510 to expose upper portions of all of the second touch pads 123w. The metal pattern 520 includes a metal material within the contact hole to allow for connection to the window pad unit 230 and the connection pad unit 112 of the first substrate 110.

By way of summation and review, one type of display device has side keys in a non-display area in order to allow for selection of various settings or control power in a touch manner. The side keys correspond to touch patterns in the non-display area, and the display area also includes touch patterns. Because the touch patterns in the display and non-display areas are both on the upper substrate, a coupling phenomenon may occur between the touch patterns in the display area and non-display areas.

Also, according to one approach, touch patterns in the display area may be separated from the touch patterns in the non-display area. However, this approach increases the size of the non-display area. In addition, the touch FPCB includes a bending region to allow the touch FPCB to be attached to the upper substrate of the OCTA. This bending region also increases the size of the non-display area. Also, these effects increase the size of a bezel region of the display to deteriorate design quality.

In accordance with one or more of the aforementioned embodiments, a display device a coupling phenomenon between touch patterns in display and non-display areas is reduced or prevented. Also, the size of the non-display area and a bezel region is reduced.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the invention as set forth in the following claims.

What is claimed is:

1. A display device, comprising:
a display panel including a display area and a non-display area;
a window to cover the display panel and including a black matrix area;
a plurality of first touch patterns in the display area;
a plurality of second touch patterns in the black matrix area; and
a touch pad region in the non-display area, the touch pad region including a plurality of first touch pads to transmit first sensing signals sensed by the first touch patterns to a predetermined destination and a plurality of second touch pads to transmit second sensing signals sensed by the second touch patterns to the predetermined destination.

2. The device as claimed in claim 1, wherein:
a surface of the window includes an edge area, and
the black matrix area is in the edge area and does not overlap the display panel.

3. The device as claimed in claim 2, wherein the black matrix area includes:
a printing layer on a window substrate;
a plurality of metal lines on the printing layer; and
the second touch patterns connected to the metal lines.

4. The device as claimed in claim 3, wherein the metal lines are connected to a window pad region on the surface of the window.

5. The device as claimed in claim 3, wherein:
the first touch patterns include an optically transparent, light-transmitting metal material, and
the second touch patterns include a metal material.

6. The device as claimed in claim 4, wherein the window pad region is on an area of the surface of the window which corresponds to the non-display area.

7. The device as claimed in claim 6, further comprising:
a metal pattern to electrically connect the window pad region and the second touch pads.

8. The device as claimed in claim 7, wherein the metal pattern penetrates an insulating layer between the display panel and the window.

9. A display device, comprising:
a display panel including a first substrate having a pixel region and a second substrate on the first substrate;
a plurality of touch patterns on the second substrate;
a touch pad region on the second substrate and including a plurality of touch pads to deliver sensing signals sensed by the touch patterns to a predetermined destination;
a connection pad region on the first substrate and including a plurality of connection pads to deliver the sensing signals sensed by the touch patterns to the predetermined destination;
a connector to connect the touch pad region and the connection pad region; and
a flexible printed circuit board (FPCB) which is connected to a side of the first substrate to deliver an image signal from an external source to the pixel region or which is connected to the connection pad region to deliver the sensing signals to the predetermined destination.

10. The device as claimed in claim 9, wherein the connector includes:
an insulating layer on the display panel; and
a metal pattern which penetrates the insulating layer to connect the touch pad region and the connection pad region.

11. The device as claimed in claim 9, wherein the first substrate includes:
a first metal wiring region to connect the connection pad region and the FPCB;
a driver integrated circuit (IC) to receive an image signal from the FPCB, generate a pixel driving control signal for the pixel region based on the image signal, and transmit the pixel driving control signal to the pixel region; and
a second metal wiring region to connect the driver IC and the FPCB.

12. A display device, comprising:
a display panel including a first substrate having a pixel region and a second substrate on the first substrate;
a window on the display panel;
a plurality of first touch patterns on the second substrate;
a touch pad region on the second substrate and including a plurality of first touch pads to receive first sensing signals sensed by the first touch patterns;
a plurality of second touch patterns on a surface of the window;
a window pad region on the surface of the window and including a plurality of window pads to receive second sensing signals sensed by the second touch patterns;
a connection pad region on the first substrate and including a plurality of connection pads to deliver the first and second sensing signals to a predetermined destination; and
a connector to connects the window pad region, the touch pad region, and the connection pad region.

13. The device as claimed in claim 12, wherein the touch pad region includes a plurality of second touch pads to receive the second sensing signals from the window pad region.

14. The device as claimed in claim 13, wherein the connector connects the window pad region to the second touch pads.

15. The device as claimed in claim 12, wherein:
the second touch patterns are in a black matrix area of the window, and
the black matrix area is an edge area of the surface of the window.

16. The device as claimed in claim 15, wherein the black matrix area includes:
a printing layer on a window substrate;
a plurality of metal lines which on the printing layer and connected to the window pad region; and
the second touch patterns connected to the metal lines.

17. The device as claimed in claim 12, wherein the connector includes:
an insulating layer between the display panel and the window; and
a metal pattern which penetrates the insulating layer in a bridge shape to connect the window pad region, the touch pad region, and the connection pad region.

18. The device as claimed in claim 12, further comprising:
an FPCB connected to the connection pad region to deliver the first and second sensing signals to the predetermined destination.

19. The device as claimed in claim 18, wherein the first substrate includes:
a first metal wiring region to connect the connection pad region and the FPCB;
a driver IC to receive an image signal from the FPCB, generate a pixel driving control signal for the pixel region based on the image signal, and transmit the pixel driving control signal to the pixel region; and
a second metal wiring region to connect the driver IC and the FPCB.

20. The device as claimed in claim 12, wherein a size of the window is greater than a size of the display panel to cover the display panel.
